(19) United States
(12) Patent Application Publication
(10) Pub. No.: US 2009/0208096 A1
(43) Pub. Date: Aug. 20, 2009

(54) TRANSFORMING MEASUREMENT DATA FOR CLASSIFICATION LEARNING

(75) Inventor: David Schaffer, Wappingers Falls, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,828

(22) PCT Filed: Apr. 10, 2007
(86) PCT No.: PCT/IB2007/051283

§ 371 Date: Nov. 6, 2008

Related U.S. Application Data
(60) Provisional application No. 60/746,905, filed on May 10, 2006.

(51) Int. Cl. G06K 9/62

(52) U.S. Cl. 382/159

(57) ABSTRACT

A system (600), apparatus (500), and method is provided for a combined transformation of measurement data so that the transformed data are suitable for input by pattern classification learning methods. Sensitivity of transformed data is reduced in the unreliable region while it is largely unchanged or enhanced everywhere else. A Gaussian transform is combined with a sigmoid function, using a combined transform module (502) in the apparatus (500) and system (600) to achieve the sensitivity reduction. A user can direct the processing via a user control subsystem (604) of the system (600) and by providing user analysis input (508) input to the apparatus (500).

The present disclosure is related to U.S. Provisional Patent Application No. 60/691,131, entitled “Transforming Measurement Data For Classification Learning”, and filed Jun. 16, 2005, with such reference being assigned to the Assignee of the present disclosure.

The present invention relates to a system, apparatus, and method for transforming original measurement data to reduce overall sensitivity in an unreliable region while enhancing the sensitivity of the data in regions where this is desired.

Measurement data can have distributions that do not well suit their use by certain pattern classification learning methods due to a large or small dynamic range. For example, consider microarrays in which a glass slide is populated with single stranded DNA. A sample is washed over such a slide so that RNA present in the sample will preferentially bind to the DNA strands. This is often done relative to a control with binding to a different type of fluorescing molecule being used to distinguish between the control and the target. The light color and intensity are then read to determine how the target is being expressed with the measurement data being logs of the ratio of the intensity of a first color and a second color.

In a typical experiment, readings for one type of microarray data are encoded as the log of a ratio of gene expression levels in test tissue and a control tissue. The numerical range of the resulting numbers can be very large, but typically will reside in a much narrower range (say plus two to minus two).

A popular pattern discrimination learning method is multi-layer perceptrons (MLP) also called feedforward neural networks. These machines require that their input data be numerical values in the range [0, 1]. Therefore in order to present these micro array data to a MLP, one must transform the original data to conform to this input data range requirement.

A function that can perform the desired transformation is a sigmoid function like the arctan function. These functions can insure that very large or very small measurement values will always map to the required range [0, 1], but at the price that differences between large values can be greatly diminished. Let us call this, “reduced sensitivity” in the range of large values. One can usually select a suitable parameter to the sigmoid function so that the sensitivity in the range typically expected is nearly linear. If the slope on the nearly-linear range is >45 degrees the sensitivity will be enhanced, if <45 degrees it will be reduced, if exactly 45 degrees it will remain unchanged.

A difficulty, however, can still occur. In the example above, the sensitivity of the transformed data will be maximum (i.e. the transform sigmoid function will have maximum derivative) near zero. This is the region where the ratio of measured values is near 1.0 where unfortunately its reliability is lowest. One would desire to have the sensitivity of the transformation very low here so that small differences would not be exploited by the learning machine where they are not reliable.

The system, apparatus and method of the present invention provide an effective and efficient way to transform the original data so as to reduce sensitivity of the overall transformation in an unreliable region while leaving it largely unchanged or enhanced everywhere else.

The present invention overcomes at least the above-noted problem of the prior art by providing an additional Gaussian transform that includes a parameter that permits tuning of the transform's width to that desired for the application in which it is being used. Further, the present invention advantageously addresses various issues surrounding the effectiveness and efficiency of current molecular diagnostic techniques. That is, the present invention will facilitate improved disease detection (e.g., both with respect to timing and accuracy), disease treatment (e.g., clear and personalized), and disease monitoring (e.g., fast and sensitive). Accordingly, the present invention is well suited to address the continuing need for real-time, faster, more sensitive, less labour-intensive and hence more cost-effective molecular diagnostic solutions suitable to replace or complement traditional techniques.

Additional benefits associated with the present invention (e.g., ability to cope with and/or effectively manage large amounts of data) will be apparent from the detailed description which follows, particularly when reviewed together with the appended figures, which figures are referenced to assist those of ordinary skill in the art to which the subject matter of the present disclosure appertains to better understand the illustrative examples of the present disclosure, wherein:

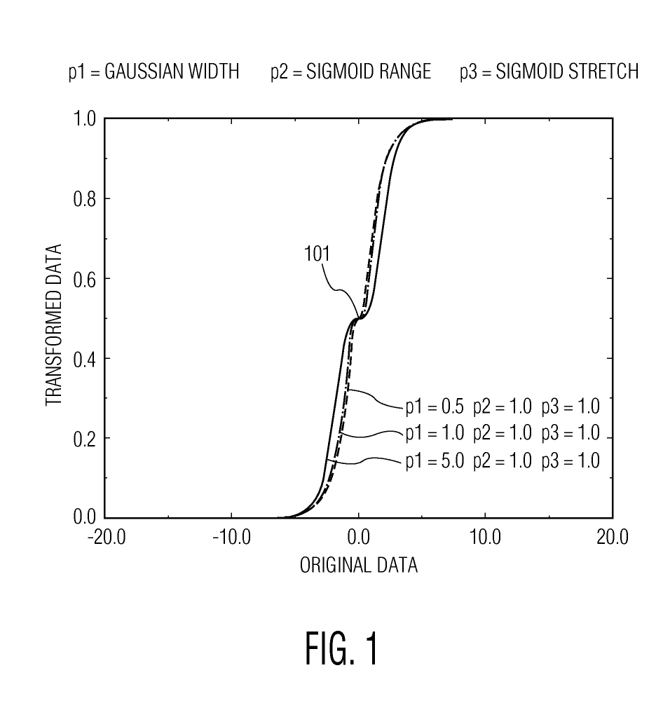

FIG. 1 transforming sample data to the range [0, 1] while varying the width of the Gaussian portion of the transform according to the present invention;

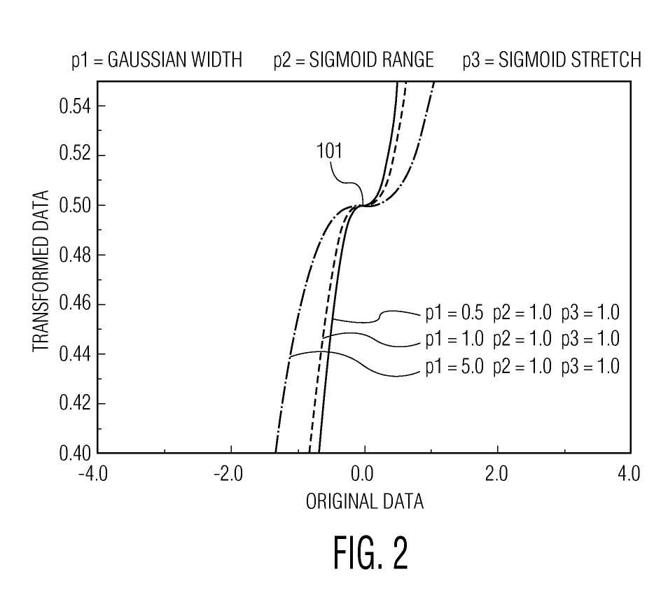

FIG. 2 illustrates only the middle plateau region of the transform of FIG. 1;

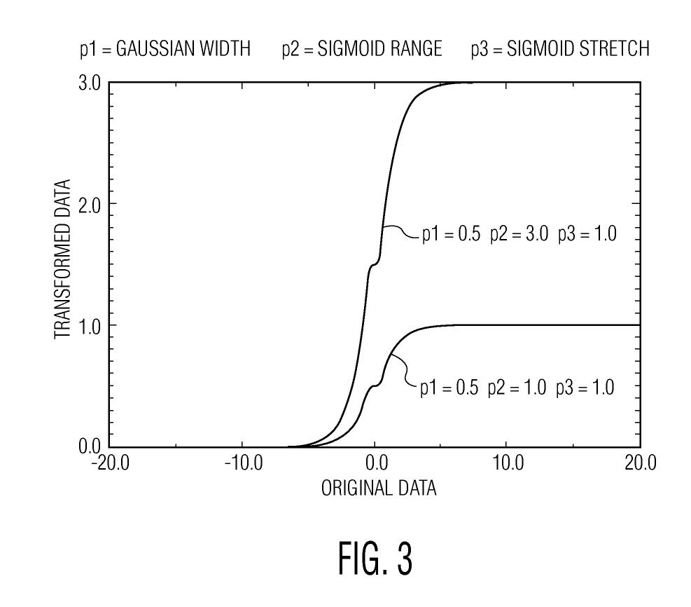

FIG. 3 illustrates varying the ceiling of the sigmoid transform component of a combined transform according to the present invention;

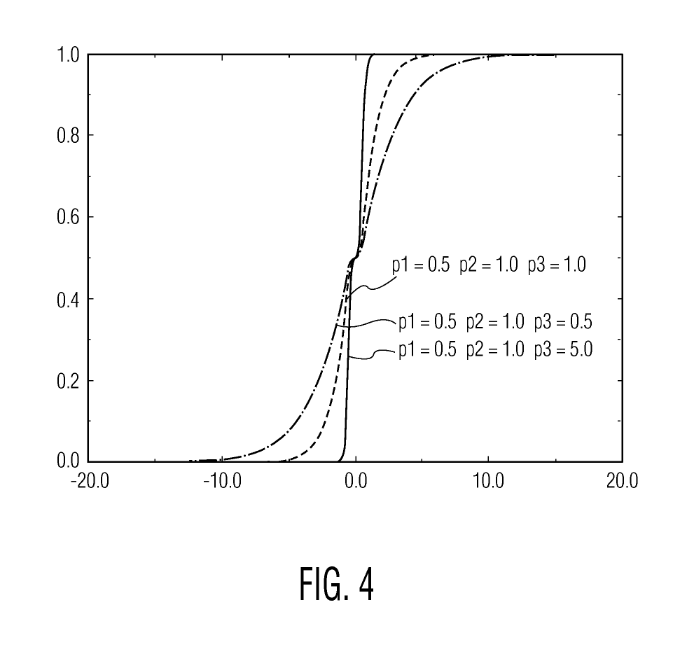

FIG. 4 illustrates varying the slope of the S-curve by pushing the tails thereof closer together and farther apart;

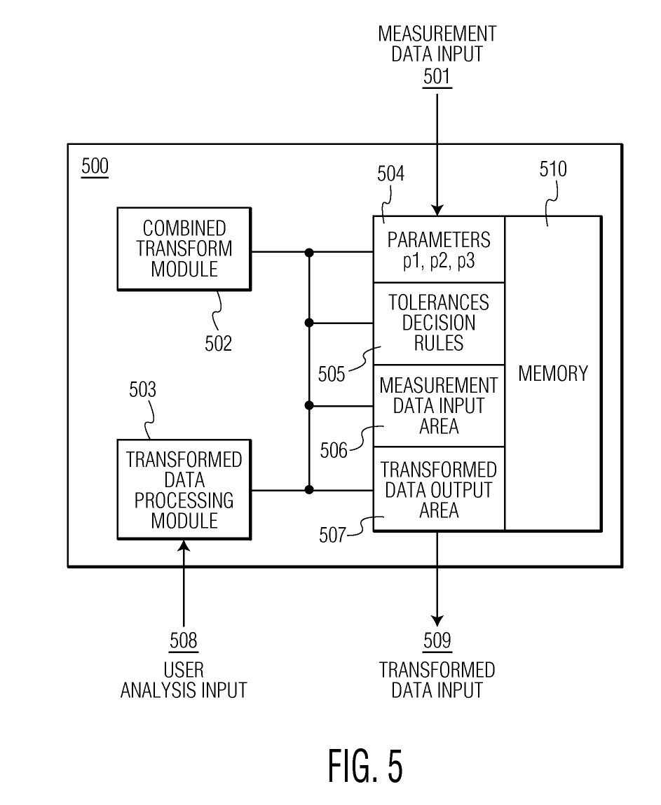

FIG. 5 illustrates an analysis apparatus modified according to the present invention; and

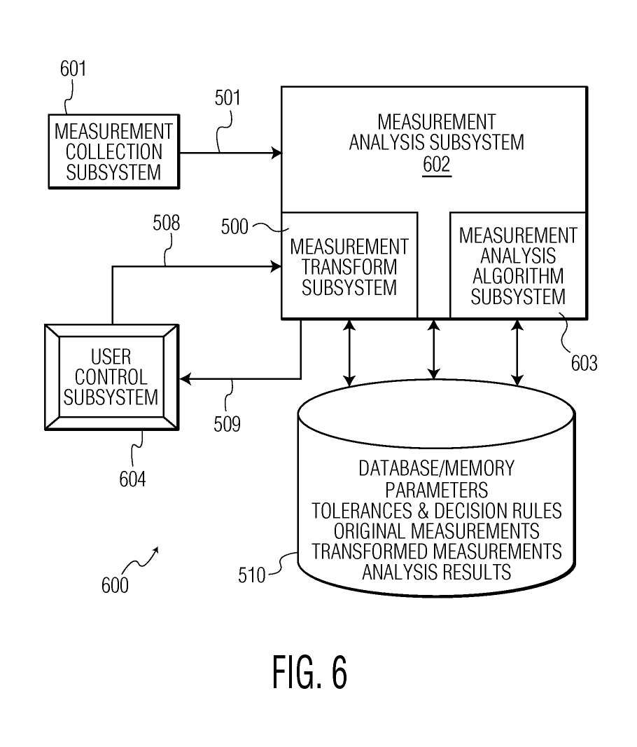

FIG. 6 illustrates a neural net analysis system including an apparatus according the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In measurement data, the distribution of the measurements may suggest transformations. For example, if a set of measurements is strongly skewed, a logarithmic, square root, or other power (between −1 and +1) may be applied. If a set of measurements has high kurtosis but low skewness, an arctan transform is used to reduce the influence of extreme values. However, the use of the arctan function creates a steepest slope at zero that the present Gaussian transform repairs. That is, the system, apparatus, and method of the present invention provide a way to transform data that reduces the sensitivity of the transformation in an unreliable region while leaving the data largely unchanged everywhere else. A second transformation is added that distorts the original data in such a way as to reduce the sensitivity of the overall transformation in the unreliable region while enhancing it or leaving it largely unchanged everywhere else.

In a preferred embodiment, an additional Gaussian transform is provided which has with its own parameter, herein p1 that permits the tuning of the width of the Gaussian transform to that desired for the application. Referring to FIG. 1, the results of varying the width parameter p1 are illustrated. This plateau 101, shown enlarged in FIG. 2, greatly reduces the sensitivity of input data values in the middle and by varying p1 (width of plateau) it is possible to greatly reduce unwanted differences among values from a sample set of data.

A preferred embodiment of a combined transformation for input of data to a Neural Net (or other pattern discrimination method) is shown in the following computer program.

It will be clear to one of ordinary skill in the art that one can have either transform independent of the other if one's task requires one and not the other property.

/*
* Map from intensity ratio scale to the [0-1] interval
* for input by a Neural Net
* Use sigmoid to cover any extreme values that may occur,
* but also to be pretty nearly linear in the “expected”
* range of values. Finally, also do a Gaussian-based distortion
* in the vicinity of zero because intensity ratios in this
* region are unreliable.
*
*/
/* ds1_transform
* input:

| | |
|---|---|
| * | x the double precision value to be transformed |
| * | p1 Gaussian width parameter |
| * | p2 sigmoid ceiling parameter |
| * | p3 sigmoid stretch parameter |

*
* output:

| | |
|---|---|
| * | transformed double precision value for x |

*
* It's straightforward to add another parameter
* if one wants a range going below zero
*/
double ds1_transform(double x, double p1, double p2, double p3)
{

| | |
|---|---|
| | double gauss; |
| | double sigmoid; |
| | double distorted_x; |
| | /* gauss distortion for x */ |
| | gauss = exp(−x*x/p1); |
| | distorted_x = x − (x*gauss); |
| | /* sigmoid */ |
| | sigmoid = p2/(1.0 + exp(−p3*distorted_x)); |
| | return(sigmoid); |
| } | |

The combined transform of the present invention can be incorporated into an analysis apparatus as at least one of a software and firmware module that accepts values for parameters p1-p3 and original input values and returns transformed values. The following main program illustrates the behavior of such an embodiment wherein a main program solicits inputs for p1-p3 from a user and prints out transformed values according to the present invention for input data in the range [−20,20] that increments in steps of 0.1 over this range. In practice, actual sample data would be input and transformed by the combination.

/*
* main accepts values of p1 - p3 from the command line
* and prints out 400 values with their transform
* in the range −20 to +20
*/
int main(int argc, char *argv[ ])
{

int i,j;
double x, p1, p2, p3;
int n_points;
double inc;
double transformed_x;
if (argc < 4)
{

fprintf(stderr,“usage: mapping2 p1 p2\n”);
fprintf(stderr,“where p1 is Gaussian width parameter\n”);
fprintf(stderr,“and p2 is sigmoid ceiling parameter\n”);
fprintf(stderr,“and p3 is sigmoid stretch parameter\n”);
exit(1);

}
else
{

p1 = atof(argv[1]);
p2 = atof(argv[2]);
p3 = atof(argv[3]);

}
n_points = 400;
inc = 0.1;
x = (double)−n_points/2.0;
x *= inc;
for (i=0; i<n_joints; i++)
{

x += inc;
transformed_x = ds1_transform(x,p1,p2,p3);
printf(“%lf%lf\n”,x, transformed_x);

}

}

Referring to FIG. 3, p2 is used therein to vary the top end of the transformation between 0 and p2. Referring to FIG. 4, p3 is used to change the slope of the S-curve by pushing the tails thereof together or apart to cover the numerical range where most data are expected. By varying p1 vs. p3 one can determine which outliers are pulled-in and by how much and whether differences between these values are enhanced or diminished.

Referring now to FIG. 5, a preferred embodiment of an analysis apparatus 500 is shown that has been modified according to the present invention. Measurement data are input 501 and includes parameters p1, p2, and p3 504, tolerances and decision rules, such as stopping conditions, that direct the process of varying p1-p3 to achieve transformed data having predetermined properties. The measurement data input 501 are stored along with the parameters 504, the tolerances and decision rules 505, and transformed output data 507 in a memory 510. In a preferred embodiment a user interacts with the transformed data analysis module by providing inputs 508 based on the user's analysis of the transformed data input 509.

Having identified certain preferred aspects of the analysis apparatus of the present disclosure, it will be readily apparent to one skilled in the art that such apparatus may effectively be utilized in association with a variety of known and/or yet to be discovered medical diagnostic or measurement techniques. For example, the apparatus of the present disclosure is well suited for, among other things, use in association with the identification, monitoring and/or treatment of disease, as well as the characterization of biological conditions via, for instance, gene expression data (see, e.g., U.S. Pat. Nos. 6,964,850, 6,960,439, and 6,692,916, which patents being hereby expressly incorporated by reference as part hereof, for further illustrative discussion).

FIG. 6 illustrates an analysis system 600 incorporating at least one device 500 modified with the apparatus of FIG. 5. The analysis system collects measurement data using a measurement collection subsystem 601 as parameters, tolerances, decision rules and provides it as measurement data input 501, used by the measurement transform subsystem 500 (modified according to the present invention) to compute transformed data input 509. The system can comprise at least one of automated tolerance testing to determine any changes to p1-p3 in accordance with predetermined requirements and a user control subsystem to direct determination of p1-p3 based on iterative user evaluation of transformed data input 509 resulting from user-provided values of p1-p3 508 that are provided as user analysis input 508 by a user control subsystem 604.

The user could make decisions based on the transformed data themselves, but more likely is that the transformed data would go directly into the analysis system 603 and use these outputs to make decisions. Initial analysis might just be computing and displaying the distribution of the transformed data, but more likely they would involve the application of pattern discovery methods and examining the discovered patterns according to some criteria of utility or reasonableness.

A persistent memory and database 500 provides short and long term storage of inputs, outputs, and intermediate results for transforming measurements by the measurement transform subsystem 500. The analysis system 600 further includes measurement analysis algorithms 603 connected to the persistent memory and database 510 that retains and makes available parameters, tolerances, decision rules, original measurements and a longitudinal history of results of transforming the original measurement data using the apparatus and method of the present invention.

Having identified certain preferred aspects of the analysis system of the present disclosure, it will be readily apparent to one skilled in the art that such apparatus may effectively be utilized in association with a variety of known and/or yet to be discovered medical diagnostic or measurement techniques. For example, as with the apparatus of the present disclosure, the system may also be well suited for, among other things, use in association with the identification, monitoring and/or treatment of disease, as well as the characterization of biological conditions via, for instance, gene expression data.

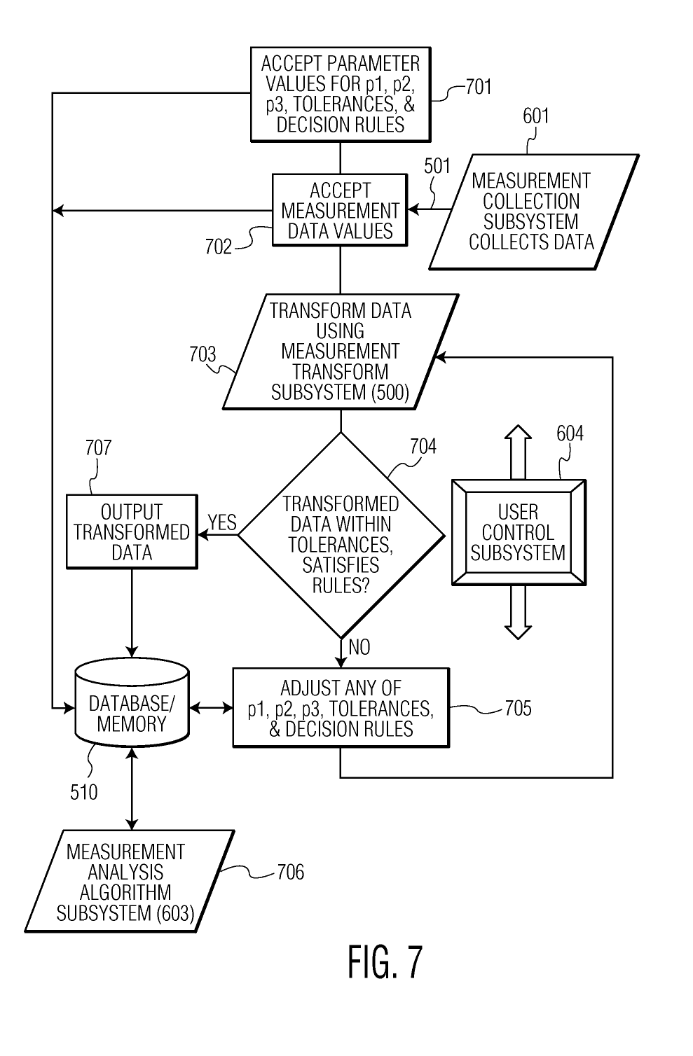

FIG. 7 is a preferred embodiment of a processing flow for the system of FIG. 6 with the flow for the apparatus of FIG. 5 contained therein. At step 701 user inputs for parameters, tolerance and decision rules are input and store in Database/Memory 510. Measurement data values are input at step 702 and stored in Database/Memory 510 that have been collected by a Measurement Subsystem 601. The measurement data are transform using the present invention by a Measurement Transform Subsystem 500 at step 703. A user Control Subsystem 604 which can range from totally manual adjustment to totally automatic adjustment checks the transformed values at step 704 and adjusts as directed by the user or automatically any of the parameters, tolerances and decision rules at step 705. If the transformed data are acceptable according to the User Control Subsystem 604 at step 704 then the transformed data are output at step 707 and stored in Database/Memory 510. Thereafter, Measurement Analysis Algorithms 603 retrieve and analyse, as described above, the transformed data from the Database/Memory 510 and store the analysis results therein.

While the preferred embodiments of the present invention have been illustrated and described, it will be understood by those skilled in the art that the system and apparatus architectures and methods as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling with the scope of the appended claims.

1. A method for transforming measurement data to an acceptable range [1, u] for input by a learning machine of a given classification learning type, comprising the steps of:
composing (502) a parameterized transform with at least one pre-determined parameterized transform to the acceptable range [1, u], that lowers sensitivity in areas of increased sensitivity of unreliable data so differences that satisfy pre-determined criteria for unreliability and undesirablity are not exploited by the learning machine;
transforming (703) the set of measurement data (702) to the acceptable range [1, u] using the composed transform;
testing (503) if the transformed data do not satisfy predetermined criteria and until a stopping criteria is met, repeatedly performing the steps of:
adjusting (705) at least one parameter (504) of the parameterized composed transform, and
performing the transforming and testing steps;
if the transformed data satisfy (704) one condition (505) selected from the group of predetermined criteria and predetermined stopping condition, outputting the transformed measurement data.

2. The method of claim 1, wherein the at least one pre-determined parameterized transform (701) is selected from the group consisting of the identity transformation where
transformed_x=x
and a sigmoid transform having parameters p2 and p3 where
p2=sigmoid ceiling
p3=sigmoid stretch
transformed_x=p2/(1−exp(−p3*x)

3. The method of claim 2, wherein the composing step (502) further comprises first performing a parameterized Gaussian (703) distortion having parameter p1 of the measurement data x where
p1=Gaussian width parameter
x=x−(x*exp(−x*x/p1).

4. The method of claim 3 wherein the classification learning type is multi-layer perceptron (MLP) and the range [1, u] is [0,1].

5. An apparatus (500) for transformation of measurement data for input by a learning machine of a given classification learning type, comprising:
a combined transform module (502) that analyses the measurement data and based on the analysis composes a parameterized transform using at least one pre-determined parameterized transform having at least one pre-determined parameter and transforms measurement data therewith to a range [1, u] acceptable to the classification learning type;
a memory (510) connected to the composition transform module for storing the pre-determined parameters, the measurement data to be transformed, and the resulting transformed data output; and
a transformed data processing module (503) that determines whether or not the transformed data satisfies predetermined satisfaction criteria and adjusts the pre-determined parameters and retransforms the measurement data therewith until one condition (505) is met from the group consisting of a stopping condition and the predetermined satisfaction criteria, wherein the transformed data input is at least one of output and stored in the memory (510).

6. The apparatus (500) of claim 5, wherein the at least one pre-determined parameterized transform (701) is selected from the group consisting of an identity transformation where
x=measurement data
transformed_x=x
and a sigmoid transform having parameters p2 and p3 where
p2=sigmoid ceiling
p3=sigmoid stretch
transformed_{—x=p2/(}1−exp(−p3*x)

7. The apparatus (500) of claim 6, wherein the combined transform module (502) is further configured to first perform a parameterized Gaussian distortion (703) having parameter p1, of the measurement data x where
p1=Gaussian width parameter
x=x−(x*exp(−x*x/p1.

8. The apparatus (500) of claim 7 wherein the classification learning type is multi-layer perceptron (MLP) and the range [1, u] is [0,1].

9. A system (600) for transformation of measurement data for input by a learning machine of a given classification learning type, comprising:
a measurement collection subsystem (601) for collection and output of measurement data;
a measurement analysis subsystem (602) comprising a measurement transform subsystem (500) and a measurement analysis algorithm subsystem (603), and that is configured to receive the measurement data output (501) by the measurement collection subsystem (601), stores the received data in a database/memory (510), transform the received data using the measurement transform subsystem (500) into a range [1, u] acceptable as input by the learning machine, analyse the measurement data using the measurement analysis algorithm subsystem (603) (706) and store the transformed data and analysis thereof in the database memory (510).

10. The system (600) of claim 9, wherein the measurement transform subsystem (500) is further configured to use at least one composed parameterized transform having at least one settable parameter and to include a user control subsystem (604) for a user to use the measurement analysis algorithms subsystem (603) to determine the quality of the transformed measurement data and direct the measurement transform subsystem (500) to transform/retransform the measurement by providing pre-determined values for the at least one settable parameter.

11. The system (600) of claim 10, wherein, the at least one composed parameterized transform (701) is selected from the group consisting of an identity transformation where
x=measurement data
transformed_x=x
and a sigmoid transform having parameters p2 and p3 where
p2=sigmoid ceiling
p3=sigmoid stretch
transformed_x=p2/(1−exp(−p3*x)

12. The system (600) of claim 11, wherein the at least one composed transform includes a first a parameterized Gaussian distortion (703) having parameter p1, of the measurement data x where
p1=Gaussian width parameter
x=x−(x*exp(−x*x/p1).

13. The system (600) of claim 12, wherein the classification learning type is multi-layer perceptron (MLP) and the range [1, u] is [0,1].

14. A molecular diagnostic method comprising the steps of:
collecting diagnostic data; and
processing the collected diagnostic data via data processing means,
wherein the processing means includes means for transforming data such that the sensitivity of the transformation is reduced in an unreliable region while unchanged or enhanced elsewhere.

15. A computer programmable medium for carrying out at least a portion of the method of claim 14.

16. A molecular diagnostic apparatus comprising:
input means for at least receiving measurement input data;
processing means at least including means for transforming data such that the sensitivity of the transformation is reduced in an unreliable region while unchanged or enhanced elsewhere; and
output means for at least outputting transformed data.

17. The apparatus of claim 16, further comprising user input means.

18. The apparatus of claim 16, wherein the means for transforming data at least includes first means for at least analysing the measurement input data and composing a parameterised transform, and second means for at least determining if transformed data is consistent with criteria and retransforming the data until at least one criteria is satisfied.

19. A computer programmable medium for accomplishing at least a part of the functionality of claim 18.

20. A molecular diagnostic system comprising:
a data collecting subsystem for at least collecting and outputting diagnostic data;
a data processing subsystem for at least analysing input data, transforming data such that the sensitivity of the transformation is reduced in an unreliable region while unchanged or enhanced elsewhere, and outputting transformed data; and
a control subsystem for at least enabling a user to interact with at least the data collecting subsystem and/or the data processing subsystem.
